(19) United States
(12) Patent Application Publication
(10) Pub. No.: US 2019/0322961 A1
(43) Pub. Date: Oct. 24, 2019

(54) MULTIPLE FRAGRANCE CANDLE

(71) Applicant: Gordon Ernest MULLER, Pretoria (ZA)

(72) Inventor: Gordon Ernest MULLER, Pretoria (ZA)

(21) Appl. No.: 16/472,201

(22) PCT Filed: Dec. 15, 2017
(86) PCT No.: PCT/IB2017/057983

§ 371 Date: Jun. 21, 2019

(30) Foreign Application Priority Data
Dec. 21, 2016 (ZA) 2016/08792

(51) Int. Cl. C11C 5/00; A01M 29/12

(52) U.S. Cl. CPC C11C 5/008; A01M 29/12; C11C 5/002

(57) ABSTRACT

A multiple fragrance candle, which includes a body having at least two cavities on different sides of the body, the body being displaceable between different positions in which at least one of the at least two cavities face upwards and a core housed within each of the at least two cavities, each of the cores having a fragrance producing substance.

### FIELD OF THE INVENTION

This invention relates to a fragrance candle. In particular, the invention relates to a multiple fragrance candle and to a method of producing a dual fragrance candle.

### BACKGROUND OF THE INVENTION

In the past, candles were mainly used for the functional purpose of providing light but now that other sources of light are readily available, candles are more frequently used for ornamental lighting. Scented candles, which release a pleasant fragrance when burned, have also become increasingly popular and are often used for festive occasions.

Some essential oils which are put into candles have additional benefits aside from their fragrant aroma, such as citronella which acts as an insect repellent.

The inventor is aware of existing fragrance candles which release a particular scent depending on the composition of the fragrance in the candle. The inventor aims to provide a new kind of scented candle through this invention.

### SUMMARY OF THE INVENTION

According to a first aspect of the invention, there is provided a multiple fragrance candle, which includes

a body of a mouldable material having at least two cavities on different sides of the body, the body being displaceable between different positions in which one of the at least two cavities face upwards;

a core housed within each of the at least two cavities, each of the cores having a fragrance producing substance.

The body may be free-standing such that it may stand in the different positions without additional support.

The body may be of a mouldable material.

The body may be of a translucent wax so that the light is not obscured by the body when any one of the cores is burned.

In one embodiment, the multiple fragrance candle may be a dual fragrance candle, which includes

a body having a first cavity on a first end of the body and a second cavity on a second end of the body, the body being displaceable between an upright position in which the first cavity faces upwards and an inverted position in which the second cavity faces upwards;

a first core housed within the first cavity, having a first fragrance; and

a second core housed within the second cavity, having a second fragrance.

The body may be in the form of a cylinder.

Each of the first- and second cores may comprise an inner portion having a wick extending through the centre and an outer portion which surrounds the inner portion.

The inner portion may have a composition similar to a standard wax candle. More particularly, the inner portion may be manufactured from any one of bee wax, petrochemical wax, palm tree wax, stearic acid wax, or the like.

The inner portion may have a composition that contains an insect repellent.

The outer portion may be of a composition which includes a fragrance producing substance to produce a fragrance when burnt.

The fragrance producing substance may include any one or both of an essential oil and a fragrance oil.

The body may include a shallow container embedded at the bottom of each cavity.

The container may be shaped and dimensioned to hold the inner portions of each core.

The container may be between 10 mm and 20 mm in height and may have a diameter which is slightly greater than that of the first- and second inner portions.

In use, the body may be placed in an upright position to burn the first core, the first cavity housing the first core being at the top of the body and the second cavity housing an inverted second core being at the bottom of the body. The body may be inverted to burn the second core, the second cavity housing the second core then being at the top of the body and the first cavity housing the inverted first core then being at the bottom of the body.

The cores may have a lower melting point than the melting point of the body, such that when either of the cores is being burned the body retains its form.

The invention extends to method of producing a dual fragrance candle, the method including

forming a body having a first and second cavity as described;

forming a first core, having a first fragrance, within the first cavity; and

forming a second core, having a second fragrance, within the second cavity.

The cores may each include an inner portion and an outer portion held in the cavities of the body.

The inner portions may be formed by pouring molten wax containing an insect repellent into a mould.

The molten wax may be left to solidify around a wick having a wick sustainer, the wick sustainer being positioned in the centre of the mould prior to pouring in the wax.

Alternatively, the molten wax of the inner portion may be left to set and a wick may then be inserted into a hole through the inner portion after the inner portion has set.

The solidified inner portion may be inserted into a shallow container which may then be inserted into the cavity.

The outer portions may be formed by pouring molten wax containing a fragrant into the cavities until it submerges the inner portions already within the cavities.

The invention is now described, by way of non-limiting example, with reference to the accompanying drawings:

### FIGURE(S)

In the figure(s):

FIG. 1a shows a sectional view of a dual fragrance candle in accordance with one aspect of the invention in an upright position;

FIG. 1b shows a sectional view of a dual fragrance candle in accordance with one aspect of the invention in an inverted position;

FIG. 2 shows a top view of the dual fragrance candle shown in FIG. 1a; and

FIG. 3 shows a three-dimensional view of the dual fragrance candle shown in FIG. 1a.

In the drawings, like reference numerals denote like parts of the invention unless otherwise indicated.

### EMBODIMENT OF THE INVENTION

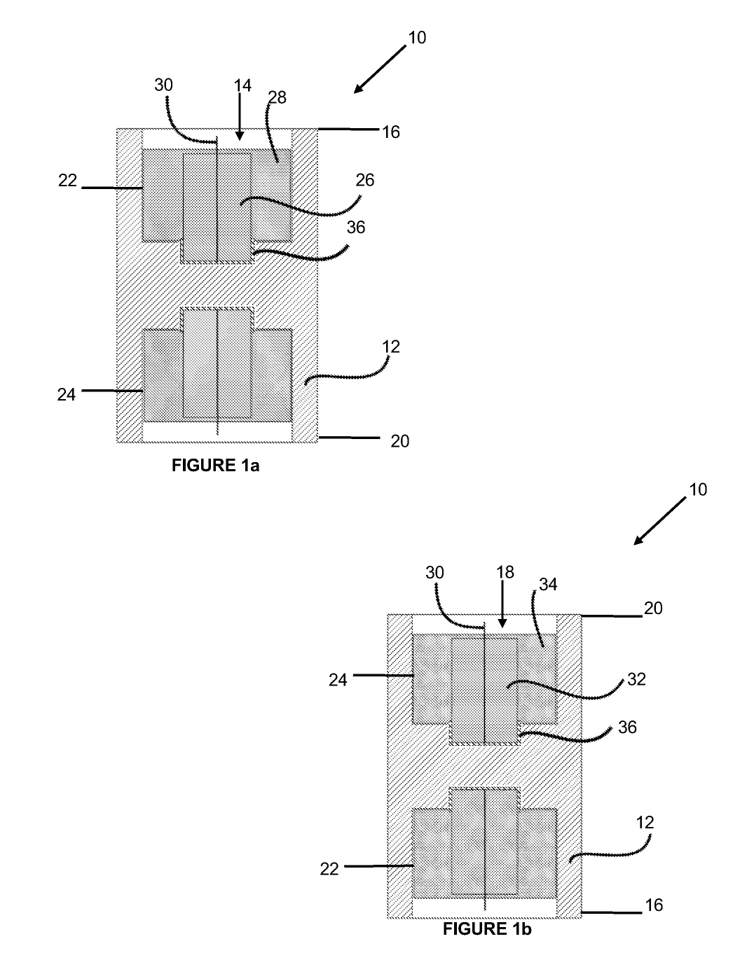

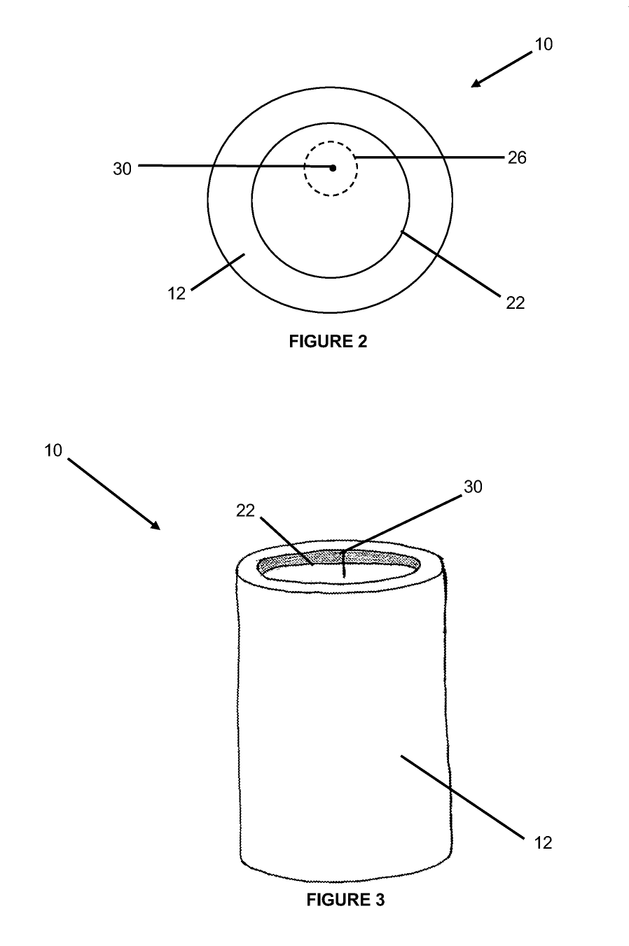

In FIGS. 1 to 3 reference numeral 10 refers to a multiple fragrance candle, more specifically a dual fragrance candle.

The dual fragrance candle 10 includes an elongate cylindrical body 12 having a first cavity 14 on a first end 16 and a second cavity 18 on a second end 20 of the body 12, the body 12 the body being displaceable between an upright position in which the first cavity 14 faces upwards and an inverted position in which the second cavity 18 faces upwards as shown in figures la and 1 b respectively. The body 12 also includes a first core 22 housed with the first cavity 14, having a first fragrance. The body 12 further includes a second core 24 housed within the second cavity 18, having a second fragrance.

In this example, the body 12 is in the form of a free-standing cylindrical shape such that it stands in an upright or inverted position without additional support as shown in FIG. 1a and FIG. 1b. The body 12 is made of translucent wax so that the light is not obscured by the body 12 when the first core 22 or second core 24 is burned.

The first core 22 comprises a first inner portion 26 having a wick 30 extending through the centre and a first outer portion 28 which submerses the first inner portion 26. The first inner portion 26 has a composition which includes an insect repellent. The first outer portion 28 has a composition which includes an essential oil, such as cedar wood, which produces the first fragrance.

The second core 24 comprises a second inner portion 32 having a wick 30 extending through the centre and a second outer portion 34 which submerses the second inner portion 32. The second inner portion 32 has a composition which includes an insect repellent. The second outer portion 34 has a composition which includes an essential oil, such as jasmine, to produce the second fragrance.

The body 12 includes a shallow container defining a wick sustainer 36 embedded below each cavity 14, 18, the container 36 being shaped and dimensioned to hold the inner portions 26, 32 of each core 22, 24. In this example the container 36 is 20mm in height, having a diameter which is slightly greater than that of the first 26 and second inner portions 32.

As shown in FIG. 1a, the body 12 is placed in an upright position to burn the first core 22. The first cavity 14 housing the first core 22 is at the top of the body 12 and the second cavity 18 housing an inverted second core 24 is at the bottom of the body 12. As shown in FIG. 1b, the body is inverted to burn the second core 24 such that the second cavity 18 housing the second core 24 is at the top of the body 12 and the first cavity 14 housing the inverted first core 22 is at the bottom of the body 12.

The first core 22 has a lower melting point than the melting point of the body 12, such that when the first core 22 is being burned the first end 16 of the body 12 retains its form. The second core 24 has a lower melting point than the melting point of the body 12, such that when the second core 24 is being burned the second end 20 of the body 12 retains its form.

It is to be appreciated that this present example only shows a dual fragrance candle, but the invention extends to a multiple fragrance candle, for example a cube.

The inventor believes that the invention provides a new multiple fragrance candle and a method of producing a dual fragrance candle, which will be of particular use in applications where insects needs to be repelled or where a pleasant fragrance is to be emitted when the candle is being burned.

1. A multiple fragrance candle, comprising:
a body having at least two cavities on different sides of the body, the body being displaceable between different positions in which one of the at least two cavities faces upwards; and
a core housed within each of the at least two cavities, each of the cores having a fragrance producing substance.

2. The multiple fragrance candle of claim 1, wherein the body is free-standing such that it can stand in the different positions without additional support.

3. The multiple fragrance candle of claim 1, wherein the body is of a mouldable material.

4. The multiple fragrance candle of claim 1, in which the body is of a translucent wax so that light is not obscured by the body when any one of the cores is burned.

5. The multiple fragrance candle of claim 1, wherein the candle is a dual fragrance candle, comprising:
a body having a first cavity on a first end of the body and a second cavity on a second end of the body, the body being displaceable between an upright position in which the first cavity faces upwards and an inverted position in which the second cavity faces upwards;
a first core housed within the first cavity, having a first fragrance; and
a second core housed within the second cavity, having a second fragrance.

6. The multiple fragrance candle of claim 5, wherein the body is in the form of a cylinder.

7. The multiple fragrance candle of claim 6, wherein each of the first and second cores comprises an inner portion having a wick extending through the centre and an outer portion which surrounds the inner portion.

8. (canceled)

9. The multiple fragrance candle of claim 7, wherein the inner portion is manufactured from any one of bee wax, petrochemical wax, palm tree wax and stearic acid wax.

10. The multiple fragrance candle as claimed in claim 7, wherein the inner portion has a composition that contains an insect repellent.

11. The multiple fragrance candle of claim 7, wherein the outer portion is of a composition which includes a fragrance producing substance in the form of any one or both of an essential oil and a fragrance oil.

12. (canceled)

13. The multiple fragrance candle of claim 7, wherein the body includes a shallow container embedded at the bottom of each cavity, wherein the shallow container is shaped and dimensioned to hold the inner portion of each core.

14. (canceled)

15. The multiple fragrance candle of claim 13, wherein the container is between 10 mm and 20 mm in height and has a diameter which is slightly greater than that of the first and second inner portions.

16. The multiple fragrance candle of claim 1, wherein the cores have a lower melting point than the melting point of the body, such that when either of the cores is being burned the body retains its form.

17. A method of producing a dual fragrance candle, comprising:
forming a body having a first cavity on a first end of the body and a second cavity on a second end of the body, the body being displaceable between an upright position in which the first cavity faces upwards and an inverted position in which the second cavity faces upwards;
forming a first core, having a first fragrance, within the first cavity; and
forming a second core, having a second fragrance, within the second cavity.

18. The method of claim 17, wherein the cores each includes an inner portion and an outer portion held in the cavities of the body.

19. The method of claim 18, wherein the inner portions are formed by pouring molten wax containing an insect repellent into a mould.

20. The method of claim 19, wherein the molten wax is left to solidify around a wick having a wick sustainer, the wick sustainer being positioned in the centre of the mould prior to pouring in the wax.

21. The method of claim 19, wherein the molten wax of the inner portion is left to set and a wick is then inserted into a hole through the inner portion after the inner portion has set.

22. The method of claim 18, wherein the inner portion is inserted into a shallow container which is then inserted into the cavity.

23. The method of claim 18, wherein the outer portions are formed by pouring molten wax containing a fragrant into the cavities.

24. (canceled)

25. (canceled)

26. (canceled)

27. (canceled)
